(19) United States
(12) Patent Application Publication
(10) Pub. No.: US 2026/0111274 A1
(43) Pub. Date: Apr. 23, 2026

(54) METHOD, DEVICE, AND COMPUTER PROGRAM PRODUCT FOR CONTAINER RESOURCE SCHEDULING

(71) Applicant: DELL PRODUCTS L.P., ROUND ROCK, TX (US)

(72) Inventors: Ran Liu, Beijing (CN); Tao Chen, Beijing (CN); Long Wang, Beijing (CN)

(21) Appl. No.: 18/960,374

(22) Filed: Nov. 26, 2024

(30) Foreign Application Priority Data
Oct. 22, 2024 (CN) 202411481840.4

(51) Int. Cl. G06F 9/50

(52) U.S. Cl. CPC G06F 9/5027

(57) ABSTRACT

Embodiments of the present disclosure relate to a method, a device, and a computer program product for container resource scheduling. The method includes detecting, in response to that there are no available virtual devices among virtual devices assigned to one or a plurality of pods on a host, whether there is a group of idle virtual devices not assigned to the one or plurality of pods. The method further includes processing, in response to the absence of the group of virtual devices, a workload of the one or plurality of pods by using a CPU of the host. The solution can promote the utilization of idle acceleration resources during a failure of a pod, and avoid unnecessary CPU occupation as much as possible, so that system resources can be used more reasonably and efficiently.

### TECHNICAL FIELD

Embodiments of the present disclosure relate to virtualization technologies, and more specifically, to a method, a device, and a computer program product for container resource scheduling.

### BACKGROUND

A host can use computing resources of its physical acceleration devices to process workloads of containers, so that a Central Processing Unit (CPU) of the host can focus on tasks such as global control and scheduling. The physical acceleration devices provide corresponding Physical Features (PF). These physical acceleration devices are also referred to as PF devices for short. For illustrative purposes, the terms “physical acceleration device” and “PF device” or similar terms herein are used interchangeably to refer to a hardware device other than the CPU that provides computing resources (for example, a hardware acceleration card in the host).

The host may utilize a device plug-in mechanism to manage and allocate physical acceleration device resources. Such plug-in can map resources of physical acceleration devices to a plurality of Virtual Function I/O (VF I/O) devices. The VF I/O device is also referred to as Virtual Function (VF) device for short. For ease of illustration, the terms “virtual device” and “VF device” or similar terms are used interchangeably herein.

### SUMMARY OF THE INVENTION

The embodiments of the present disclosure provide a solution for container resource scheduling.

In a first aspect of the present disclosure, a method for container resource scheduling is provided, including: detecting, in response to that there are no available virtual devices among virtual devices assigned to one or a plurality of pods on a host, whether there is a group of idle virtual devices not assigned to the one or plurality of pods, wherein each virtual device is operated by a physical acceleration device among a plurality of physical acceleration devices of the host; and processing, in response to the absence of the group of virtual devices, a workload of the one or plurality of pods by using a central processing unit (CPU) of the host.

In a second aspect of the present disclosure, an electronic device including a processor and a memory coupled to the processor is provided. The memory has instructions stored thereon, and the instructions, when executed by the processor, cause the device to perform actions including: detecting, in response to that there are no available virtual devices among virtual devices assigned to one or a plurality of pods on a host, whether there is a group of idle virtual devices not assigned to the one or plurality of pods, wherein each virtual device is operated by a physical acceleration device among a plurality of physical acceleration devices of the host; and processing, in response to the absence of the group of virtual devices, a workload of the one or plurality of pods by using a CPU of the host.

In a third aspect of the present disclosure, a computer program product is provided. The computer program product is tangibly stored on a computer-readable medium and includes machine-executable instructions. The machine-executable instructions, when executed, cause a machine to perform the method according to the first aspect of the present disclosure.

It should be noted that the Summary of the Invention part is provided to introduce a selection of concepts in a simplified manner, which will be further described in the Detailed Description below. The Summary of the Invention part is neither intended to identify key features or major features of the present disclosure, nor intended to limit the scope of the present disclosure.

### BRIEF DESCRIPTION OF THE DRAWINGS

The above and other objectives, features, and advantages of the present disclosure will become more apparent by description of example embodiments of the present disclosure in more detail with reference to the drawings in which:

FIG. 1 shows a schematic diagram of an example environment in which a plurality of embodiments of the present disclosure can be implemented;

FIG. 2 shows a flow chart of an example method for container resource scheduling according to some embodiments of the present disclosure;

FIG. 3 shows an example scenario where a physical acceleration device fails;

FIG. 4 shows an example scenario after failure handling of the pod in the example scenario of FIG. 3;

FIG. 5 shows a schematic diagram of resource occupation of a physical acceleration device on an example system;

FIG. 6 shows a schematic diagram of resource occupation after a physical acceleration device in the example system of FIG. 5 fails;

FIG. 7 shows a schematic diagram of resource occupation after the failed physical acceleration device in the example system of FIG. 6 has been recovered; and

FIG. 8 shows a schematic block diagram of a device that can be used to implement embodiments of the present disclosure.

In all the drawings, the same or similar reference numerals represent the same or similar elements.

### DETAILED DESCRIPTION

The embodiments of the present disclosure will be described below in further detail with reference to the accompanying drawings. Although the accompanying drawings show some embodiments of the present disclosure, it should be understood that the present disclosure may be implemented in various forms, and should not be explained as being limited to the embodiments stated herein. Rather, these embodiments are provided for understanding the present disclosure more thoroughly and completely. It should be understood that the accompanying drawings and embodiments of the present disclosure are for illustrative purposes only, and are not intended to limit the scope of protection of the present disclosure.

The term “include” and variants thereof used herein mean open-ended inclusion, i.e., “including but not limited to.” The term “based on” is “based at least in part on.” The term “one embodiment” means “at least one embodiment”; and the term “another embodiment” means “at least one other embodiment.” Relevant definitions of other terms will be given in the description below.

As used herein, depending on the context, “meeting a threshold” may, depending on the context, refer to the value being greater than the threshold, greater than or equal to the threshold, equal to the threshold, less than or equal to the threshold, less than the threshold, and the like.

A host can use computing resources of its physical acceleration devices to process workloads of containers, so that a CPU of the host can focus on tasks such as global control and scheduling. An example of the physical acceleration device may be a Quick Assist Technology (QAT) accelerator device. A plurality of virtual devices, that is, VF devices, may operate on a single physical acceleration device. The VF device is a virtual instance created by the virtualization technology on a physical acceleration device, and resources required by the VF device to operate are actually provided by the associated physical acceleration device.

By using the container technologies, a plurality of pods can be created on the host. Each pod includes one or a plurality of containers and operates as a minimum deployable and manageable computing unit. Containers in a pod work together and share a variety of storage, network, and other resources. For example, containers that provide specific services or applications may be organized into pods. Each pod may be assigned a group of VF devices for performing a workload of the pod.

When a physical acceleration device fails or is unavailable/offline for other reasons, VF devices thereon may also become unavailable. In conventional failure handling, when a VF device becomes unavailable, a CPU Fallback mechanism may be applied to temporarily direct the workload processed by the VF device to the CPU of the host for processing. A containerized application is not able to be aware of other VF devices on the host that are not assigned to it, and therefore, the workload of the pod is transferred directly to the CPU for processing in a period when the VF devices assigned to the pod all become unavailable.

However, the host may include a plurality of physical acceleration devices (for example, in the form of a hardware acceleration card). While a VF device assigned to a pod becomes unavailable because the corresponding physical acceleration device becomes unavailable, other physical acceleration devices on the host may still have available idle VF devices. However, the application of the pod itself is not able to be aware of the existence of the idle VF devices which are not assigned to it, and the workload thereof is still allocated, through the CPU fallback mechanism, to the CPU of the host for processing, thus causing unnecessary CPU occupation.

To at least partially solve the above problems and other potential problems, the embodiments of the present disclosure provide a solution for container resource scheduling. The solution first detects, when there are no available virtual devices among virtual devices assigned to one or a plurality of pods on a host, whether there is an idle virtual device not assigned to the one or plurality of pods. Only when such idle virtual device is not detected, the solution may process a workload of the one or plurality of pods by using a CPU of the host.

In this way, idle acceleration resources that may be used to process the workload of a failed pod can be found globally as much as possible before the failure handling mechanism for the pod has to occupy CPU resources. In this way, it is feasible to promote the full utilization of acceleration resources and avoid unnecessary CPU occupation, thereby utilizing system resources more reasonably and efficiently, and reducing the impact of device failures on the system performance. Some embodiments of the present disclosure can be well adapted to a cluster environment of containerized applications.

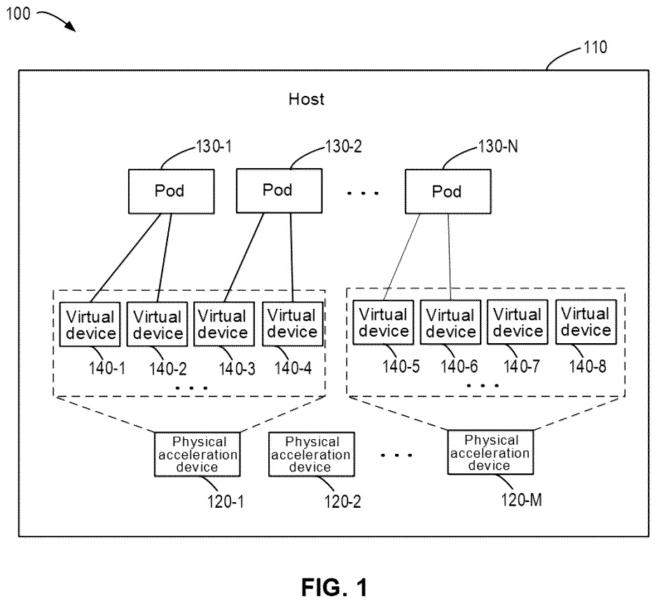

FIG. 1 shows a schematic diagram of an example environment 100 in which embodiments of the present disclosure can be implemented. As shown in FIG. 1, the environment 100 includes a host 110. As a non-limiting example, the host 110 may be a node server in a platform of a provider of a service such as data storage and/or data protection. Although shown as a separate entity, the host 110 may also exist in another form such as distributed, as long as it can include components required by the embodiments of the present disclosure.

The host 110 includes a CPU (not shown) and a group of physical acceleration devices 120-1, 120-2, . . . , and 120-M (individually or collectively referred to as a physical acceleration device 120). Each physical acceleration device 120 may instantiate a plurality of virtual devices to provide computing resources for various workloads on the host 110, for example, compression and decompression of data, encryption and decryption, and the like. For example, the physical acceleration device 120-1 has associated virtual devices 140-1 to 140-4, and the like, and the physical acceleration device 120-M has associated virtual devices 140-5 to 140-8.

A plurality of pods 130-1, 130-2, . . . , and 130-N (individually or collectively referred to as a pod 130) also operate on the host 110. The virtual device 140 may be assigned as a resource to a pod 130 for processing a workload for the pod 130. For example, the pod 130-1 is assigned virtual devices 140-1 and 140-2, the pod 130-2 is assigned virtual devices 140-3 and 140-4, and the pod 130-N is assigned virtual devices 140-7 and 140-8. It should be understood that the number of components shown in FIG. 1 is an example only, and the host 110 can include more or fewer such components. In addition, the number of other types of components associated with the component is only an example. For example, the pod 130 may be assigned more or fewer virtual devices 140.

The architecture and functions in the example environment 100 are described for illustrative purposes only, without implying any limitation to the scope of the present disclosure. There may also be other devices, systems, or components that are not shown in the example environment 200. For example, a control plug-in for globally managing and scheduling acceleration device resources may also be included on the host 110. The control plug-in can map resources of physical acceleration devices into a plurality of virtual devices and integrate them into a container orchestration platform for subsequent management and scheduling. For example, the environment 110 may further include various terminal devices requesting the host 110 for various services. In addition, the embodiments of the present disclosure may also be applied to other environments with different structures and/or functions.

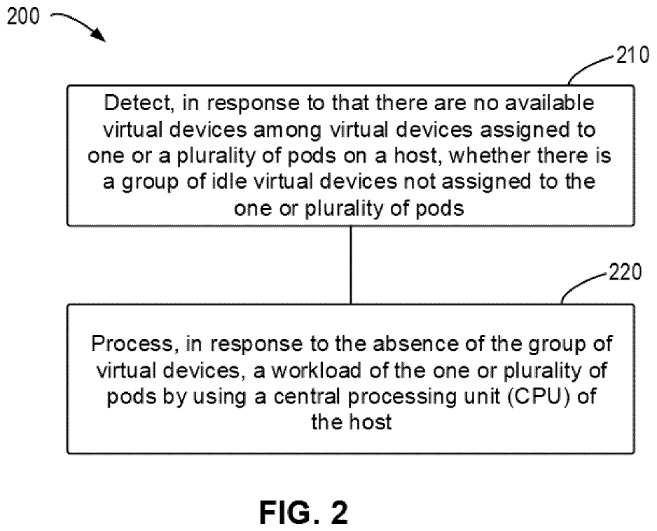

FIG. 2 shows a flow chart of an example method 200 for container resource scheduling according to some embodiments of the present disclosure. For example, the example method 200 may be performed by the host 110 as shown in FIG. 1. It should be understood that the method 100 may also include additional actions not shown, and the scope of the present disclosure is not limited in this regard. The method 200 will be described in detail below with reference to the example environment 100 in FIG. 1.

At 210, in response to that there are no available virtual devices among virtual devices assigned to one or a plurality of pods on a host, it is detected whether there is a group of idle virtual devices not assigned to the one or plurality of pods, wherein each virtual device is operated by a physical acceleration device among a plurality of physical acceleration devices of the host.

For example, when there are no available virtual devices among the virtual devices 140 assigned to the one or plurality of pods 130 on the host 110 (for example, failed or otherwise offline), the host 110 may detect (for example, by utilizing a control plug-in for an acceleration device) whether there is a group of idle virtual devices not assigned to the one or plurality of pods, wherein each virtual device is operated by a physical acceleration device among the plurality of physical acceleration devices 120 of the host.

During operation of the host 110, the physical acceleration device 120 may become unavailable due to a failure or the like, and then the virtual devices 140 associated therewith become unavailable. For example, when the physical acceleration device 120-1 is unavailable, the virtual devices 140-1 to 140-4 assigned to the pods 130-1 and 130-2 become unavailable. In this case, no virtual device will be available to process the workloads of the pods 130-1 and 130-2. In this regard, the host 110 may detect whether there are virtual devices on other physical acceleration devices 140 of the host 110 that are not assigned to the pod.

At 220, in response to the absence of the group of virtual devices, a workload of the one or plurality of pods is processed by using a central processing unit (CPU) of the host. For example, if such group of idle virtual devices is not detected at 210, the host 110 uses its CPU to process the workloads of the pods 130-1 and 130-2 associated with the unavailable virtual devices. In other words, the host 110 may apply a CPU fallback mechanism to direct the workloads of the pods 130-1 and 130-2 to its CPU for execution. In this way, when some of the physical acceleration devices fail, the businesses of the pods originally associated therewith can continue to operate normally.

Using the method 200, a failure handling mechanism for a pod can be optimized. The global-wide detection is performed before the containerized application has to occupy the CPU resources of the host, and it is possible to find idle acceleration resources for processing the workload of the failed pod, thereby avoiding unnecessary CPU occupation, and enabling the host resources to be more reasonably utilized.

In some embodiments, the host 110 may detect that there is a group of idle virtual devices. For example, in the example in FIG. 1, the host 110 may detect idle virtual devices 140-7 and 140-8 on the physical acceleration device 120-M. Further, the host 110 may assign the detected group of virtual devices to at least one pod in the one or plurality of pods for processing the workload of the at least one pod.

In some cases, depending on what is required to operate the workload of the one or plurality of pods, the idle virtual devices may not be sufficient to be assigned to all the pods in the one or plurality of pods. In some such embodiments, after the idle virtual devices are all assigned, the host 110 may use its CPU to process the workloads of other pods in the one or plurality of pods than the at least one pod, that is, apply the CPU fallback mechanism to the other pods. In this way, it can be ensured that the business of the pod originally associated with the failed physical acceleration device can continue to operate normally, while occupying the CPU resources as little as possible.

For example, in the example in FIG. 1, it is assumed that the idle virtual devices 140-7 and 140-8 are only sufficient to process the workload of one pod. The host 110 may assign them to one pod of the pods 130-1 and 130-2, and apply the CPU fallback mechanism for the other pod.

In some embodiment, the host 110 may determine at least one pod based on types of respective workloads of the one or plurality of pods, so as to assign a detected group of idle virtual devices to the at least one pod. In some such embodiments, the host 110 may determine, based on the types of respective workloads of the one or plurality of pods, priorities for assigning the idle virtual devices to the one or plurality of pods. Further, the host 110 may determine the at least one pod based on the determined priorities and the number of idle virtual devices.

For example, during execution, the host 110 may assign a desired number of virtual devices (for example, determined in real time according to the configuration or workload) to the one or plurality of pods according to the priorities until all the idle virtual devices are assigned, thereby assigning the idle virtual devices to the at least one pod.

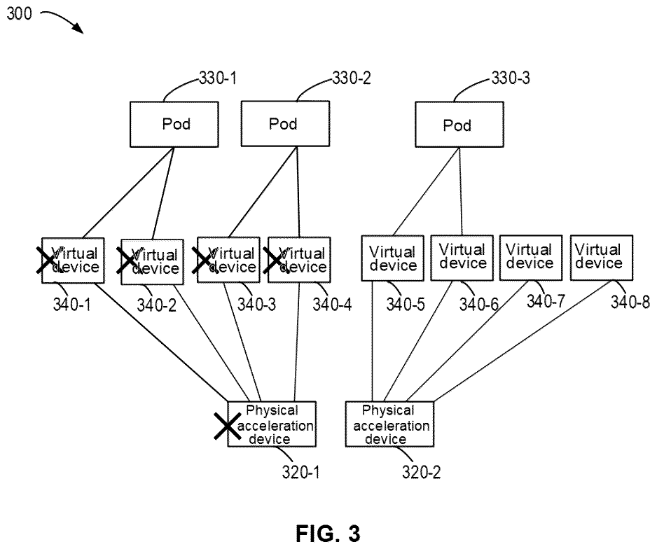

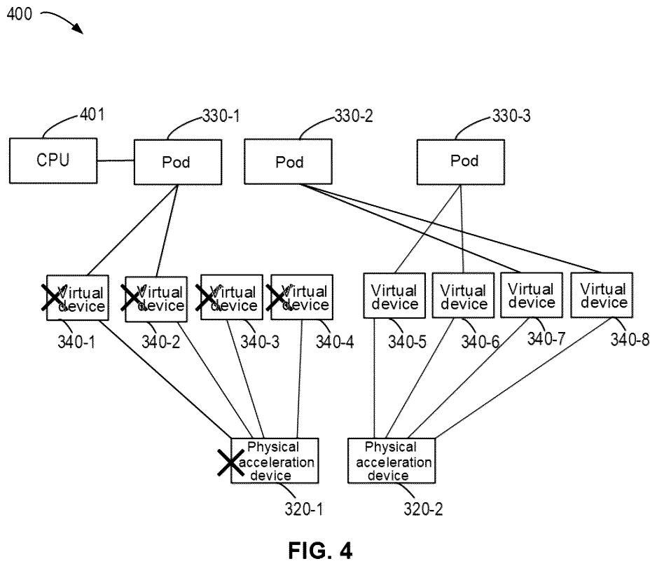

The assigning of idle virtual devices will be described below more specifically with reference to FIG. 3 and FIG. 4. It should be understood that the numbers of the various types of components in FIG. 3 and FIG. 4 and the numbers of other types of components associated with the components are shown only as examples. The embodiments of the present disclosure are applicable to any suitable number of physical acceleration devices, virtual devices, and/or pods. In different embodiments, any appropriate number of virtual devices may be created on a physical acceleration device, and a pod may be assigned any appropriate number of virtual devices.

Referring to FIG. 3 now, it shows an example scenario 300 where a physical acceleration device fails. The example scenario 300 may, for example, occur on the host 110 of FIG. 1. Physical acceleration devices 320-1 and 320-1 are shown in the example scenario 300, where each physical acceleration device is mapped into a plurality of virtual devices. These virtual devices are assigned to three pods 330-1, 330-2, and 330-3 that are operating. The pod 330-1 is assigned virtual devices 340-1 and 340-2 created on the physical acceleration device 320-1, the pod 330-2 is assigned virtual devices 340-3 and 340-4 created on the physical acceleration device 320-1, and the pod 330-3 is assigned virtual devices 340-5 and 340-6 created on the physical acceleration device 320-2.

As shown in FIG. 3, in the example scenario 300, the physical acceleration device 320-1 becomes unavailable due to, for example, a failure, and therefore, the associated virtual devices 340-1, 340-2, 340-3, and 340-4 become unavailable. Further, the pod 330-1 and the pod 330-2 will not have available virtual devices to perform workloads thereof.

To ensure that the workloads of the pods 330-1 and 330-2 can continue to be processed, the host (for example, the host 110) on which the pods reside may detect (for example, by utilizing a control plug-in) whether there are other virtual devices available on another physical acceleration device. As shown in FIG. 3, the host may detect that there are still idle virtual devices 340-7 and 340-8 on the physical acceleration device 320-2. Accordingly, the host may assign the virtual devices 340-7 and 340-8 to the pods 330-1 and 330-2 to process the workloads of the pods before applying the CPU fallback mechanism.

For illustrative purposes, in the example scenario 300, it is assumed that when using the resources of the physical acceleration device, each pod requires at least two virtual devices to perform the workload thereof. Accordingly, the virtual devices 340-7 and 340-8 are insufficient to be assigned to the two pods 330-1 and 330-2. In such case, the host may assign the virtual devices 340-7 and 340-8 to one of the pods. For the remaining pod that needs to be repaired, the CPU fallback may be applied to reassign the workload of the remaining pod to the CPU of the host for processing.

Referring to FIG. 4 now, it shows an example scenario 400 after failure handling of the pod in the example scenario 300. As shown in FIG. 4, the host may assign the detected idle virtual devices 340-7 and 340-8 to the pod 330-2. For the remaining failed pod 330-1, the host reassigns its workload to a CPU 401 for processing. In this way, the workloads of all pods can continue to be processed normally, thereby avoiding business interruption.

In some embodiments, the host may randomly select a pod from pods to be repaired to assign virtual devices based on the number of idle virtual devices. In some other embodiments, the host may be concerned with the Quality of Service when selecting the pod, and thus take into account the workload types of various pods.

Different types of business services account for different proportions in the workload of the pod. For example, for services supported by QAT devices, recovery services require more resources to decompress, while ingestion services require a balance between encryption (for example, SHA1) computations and compression/decompression. On the other hand, different types of workloads have different degrees of CPU consumption. For example, when using the CPU fallback, compression consumes more CPU resources than decompression, and decompression consumes more CPU resources than encryption.

Applying the CPU fallback for a pod with a high percentage of encryption workload has a less impact on the host CPU than for a pod with compression as the main workload. Therefore, when assigning idle virtual devices, the virtual devices should be assigned preferentially to a pod whose workload is mainly compression/decompression. The example scenario 400 is used as an example. It is assumed that the workload of the pod 330-1 is mainly SHA1, and the workload of 330-2 is mainly compression; therefore, the host may assign the virtual devices 340-7 and 340-8 to the pod 330-2 and use the CPU fallback for the pod 330-1.

In practice, a single pod often has a plurality of types of workloads. For example, the workload of the pod 330-1 may consist of partial decompression and partial SHA1. In some embodiments, for a corresponding pod in the one or plurality of pods that need to be repaired, the host may determine a priority score for the corresponding pod based on proportions of the respective types of workloads of the corresponding pod in its total workload and consumption levels of the respective types of workloads for computing resources. Based on the respective priority scores for the group of virtual devices, the host may determine the priorities for assigning the virtual devices thereto.

In some embodiments, according to CPU consumption of a specific type of workload (for example, CPU consumption of a unit workload), a weight may be set for the type of workload. The weight may depend on factors such as a hardware device condition, and may be predetermined based on experience, experimental testing, and the like. For example, the host may store a configuration file that includes weights for various types for use in failure handling. For example, during operation of a pod, the host may also track its business, thereby determining types of workloads of the pod and proportions of the various types in the total workload. Other appropriate methods for acquiring weight information and proportions of various loads of the pod may also be used.

Table 1 shows example weights for some example types of workloads in one example implementation. It should be understood that specific numerals in Table 1 are merely schematic and do not limit the scope of the present disclosure. Depending on the implementation, weights of other values may also be used. On this basis, the host may determine a priority score of a pod according to the workload types of the pod and the CPU consumption weights for the various types of loads. Then, the host may sort the priority scores of various pods to determine priorities of the various pods that need to be repaired. The pod with a higher priority score has a higher priority of being assigned a virtual device.

TABLE 1
Weights for Workload Types

| | CPU Consumption Weight |
|---|---|
| SHA1 | 1 |
| Decompression | 2 |
| Compression | 3 |

In one example implementation, it is assumed that the workload of a pod contains m % SHA1-type workload and n % decompression-type workload, and then a priority score P of the pod may be as follows, where cpu_weight_{SHA1} indicates a CPU consumption weight of the SHA1 operation, and cpu_weight_{decomp} indicates a CPU consumption weight of the decompression operation.

$$P = {cpu\_weight}_{SHA 1} \times m \% + {cpu\_weight}_{decomp} \times n \%$$

Taking the values in Table 1 as an example, it is assumed that the pod 330-1 includes 80% SHA1 workload and 20% decompression workload, and its priority score may be determined as 1*80%+2*20%=1.2. It is assumed that the pod 330-2 includes 40% SHA workload and 60% decompression workload, and its priority score may be determined as 1*40%+2*60%=1.6. Therefore, the host may assign the virtual devices 340-7 and 340-8 to the pod 330-2 with the higher score.

The above method is also applicable in a case where there are more pods that need to be repaired. The host may assign the required numbers of virtual devices to the pods sequentially according to the sorting of the priority scores of the various pods until the idle virtual devices are all assigned. If there is still a remaining pod that does not have an available virtual device at this moment, the host assigns the workload of the remaining pod to the CPU for processing. In this manner, the pressure on the CPU of the host can be reduced as much as possible when handling the pod failure.

After the failed physical acceleration device is recovered, the VF devices thereon also become available again. In some embodiments, if it is detected that unavailable VF devices are recovered, the host may detect whether there is a pod on the host that does not have an available VF device. That is, none of the VF devices currently assigned to the pod are available, and the workload thereof may need to be redirected to another component for processing or is being processed by the CPU of the host.

If such pod is detected, the host may assign the recovered VF devices to the detected pod for performing the workload for this/these pod(s). In this way, the recovered acceleration computing resources may be assigned again to the pod in need to avoid or stop applying the CPU fallback mechanism to the pod, thereby reducing the CPU burden.

If load balancing is considered in the assignment of VF devices during normal system operation, each physical acceleration device will have a relatively equal number of non-idle VF devices. When some of the PF devices fail, and after the VF devices are reassigned to pods according to the embodiments of the present disclosure, the affected workload will be actually transferred to the remaining available PF devices for processing. In this way, if the physical acceleration device does not adjust the resource assignment after the device is recovered, the loads on the PFs will become unbalanced.

Therefore, in some embodiments, after the recovered VF devices are assigned to the pods, the host may detect occupation rates of respective VF devices of the plurality of physical acceleration devices thereon. Based on the occupation rates, the host may adjust the assignment of the VF devices of the plurality of physical acceleration devices among the respective pods on the host, that is, perform load balancing on the physical acceleration devices.

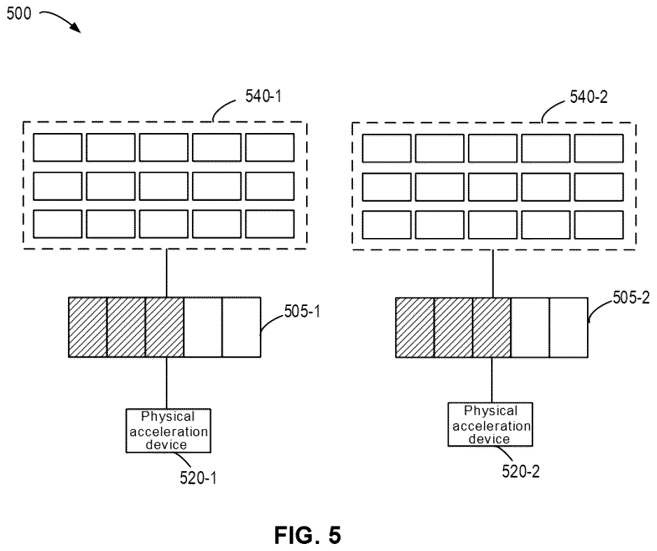

As an example, FIG. 5 shows a schematic diagram 500 of resource occupation of a physical acceleration device on an example system. The schematic diagram 500 shows that two physical acceleration devices 520-1 and 520-2 that operate normally are included in the example system. In addition, reference numerals 540-1 and 540-2 show occupied virtual devices of the physical acceleration devices 520-1 and 520-2 that are assigned to the pod, respectively. In the example, it is assumed that the physical acceleration devices 520-1 and 520-2 have a similar quantity of compute resources. Reference numerals 505-1 and 505-2 show virtual device occupation conditions at this moment for the two physical acceleration devices, respectively. As shown in the figure, resource occupation rates of the two physical acceleration devices are approximately equal at this point.

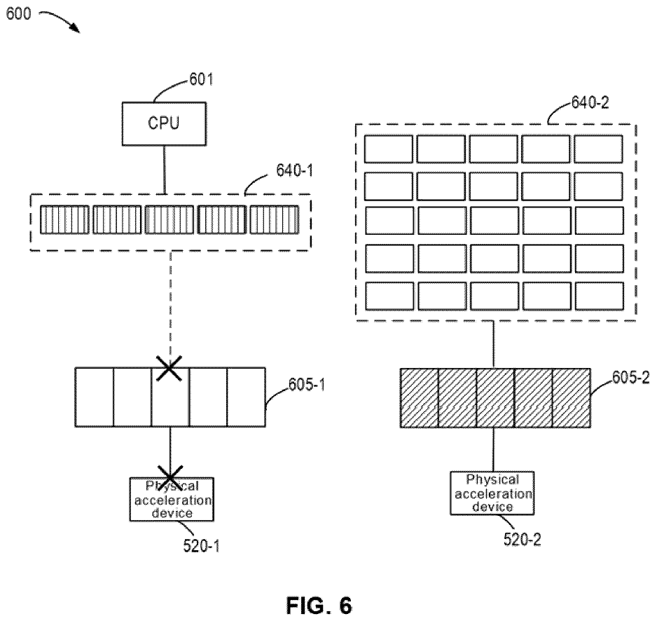

Further, FIG. 6 shows a schematic diagram 600 of resource occupation after a physical acceleration device on the example system of FIG. 5 fails. As shown in FIG. 6, the physical acceleration device 520-1 fails, and then the virtual devices thereon become unavailable, as shown by a reference numeral 605-1. In this case, according to the above embodiments of the present disclosure, the host may detect that the physical acceleration device 520-2 still has idle virtual devices. Accordingly, the host may assign these idle virtual devices to the pods whose workloads are originally processed by the physical acceleration device 520-1.

As previously described, the host may determine the priorities of these pods and assign the idle virtual devices of the physical acceleration device 520-2 to the pods sequentially. In the example, all idle virtual devices on the acceleration device 520-1 are assigned such that the proportion of occupied virtual devices thereon reaches 100%, as shown by reference numerals 640-2 and 605-2.

In the example, at this moment, there is still a pod on the host that has no available virtual devices due to the failure of the physical acceleration device 520-1. Therefore, the host may assign the workloads of these pods to its CPU 601 for processing, as shown by a reference numeral 640-1.

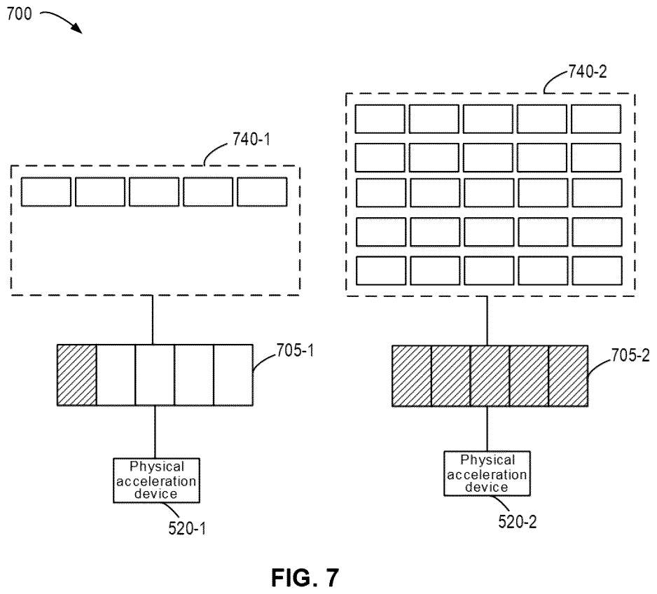

Later, the physical acceleration device 520-1 may be recovered in troubleshooting. FIG. 7 shows a schematic diagram 700 of resource occupation after the failed physical acceleration device in the example system of FIG. 6 has been recovered. After the physical acceleration device 520-1 is recovered, the virtual devices thereon become available again. At this moment, the host may detect whether there is a pod that does not have available virtual devices. In the example, the host may detect the pods whose workloads are previously assigned to the CPU 601 for execution.

Further, the host may assign the available virtual devices on the physical acceleration device 520-1 to the detected pods to process the workloads of those pods, as shown by a reference numeral 740-1. In this case, the virtual devices on the physical acceleration device 520-2 still remain fully occupied, while the virtual devices on the physical acceleration device 520-1 have low occupation rates, as shown by reference numerals 705-1 and 705-2.

Accordingly, in some embodiments, the host may check occupation rates of the virtual devices on various physical acceleration devices and reassign the virtual devices based on the occupation rates, such that workloads of some containers are migrated from the physical acceleration devices with a high virtual device occupation rate to the physical acceleration devices with a low virtual device occupation rate. In this way, the resource occupation of the various physical acceleration devices becomes more balanced, so that the system resources can be used more reasonably and efficiently. For example, for the example in FIG. 7, the host may perform load balancing on the physical acceleration devices 520-1 and 520-2, so that the occupation conditions of the various physical acceleration devices return to the state shown in FIG. 5.

It should be understood that the numbers of various devices shown in FIG. 5 to FIG. 7 are merely used as examples rather than limitations. For example, for more than two physical acceleration devices, load balancing may be similarly performed, so that the resource occupation rates of the various physical devices are closer. In an implementation, any appropriate load balancing method may be used to determine the specific reassignment of virtual devices.

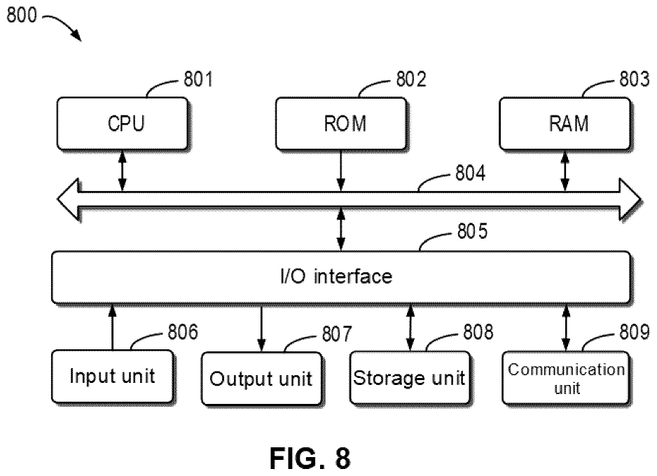

FIG. 8 shows a schematic block diagram of a device 800 that can be configured to implement embodiments of the present disclosure. The device 800 may be the device or apparatus described in the embodiments of the present disclosure. As shown in FIG. 8, the device 800 includes a CPU 801 that may perform various appropriate actions and processing according to computer program instructions stored in a read-only memory (ROM) 802 or computer program instructions loaded from a storage unit 808 into a random access memory (RAM) 803. Various programs and data required for the operation of the device 800 may also be stored in the RAM 803. The CPU 801, the ROM 802, and the RAM 803 are connected to each other through a bus 804. An input/output (I/O) interface 805 is also connected to the bus 804. Although not shown in FIG. 8, the device 800 may also include a co-processor.

A plurality of components in the device 800 are connected to the I/O interface 805, including: an input unit 806 such as a keyboard and a mouse; an output unit 807 such as various types of display and speaker; the storage unit 808 such as a magnetic disk and an optical disc; and a communication unit 809 such as a network card, a modem, and a wireless communication transceiver. The communication unit 809 allows the device 800 to exchange information/data with other devices via a computer network, such as the Internet, and/or various telecommunication networks.

The various methods or processes described above may be performed by the processing unit 801. For example, in some embodiments, the method may be implemented as a computer software program that is tangibly included in a machine-readable medium, such as the storage unit 808. In some embodiments, part of or all the computer program may be loaded into and/or installed onto the device 800 via the ROM 802 and/or the communication unit 809. When the computer program is loaded into the RAM 803 and executed by the CPU 801, one or more steps or actions of the methods or processes described above may be implemented.

In some embodiments, the methods and processes described above may be implemented as a computer program product. The computer program product may include a computer-readable storage medium on which computer-readable program instructions for performing various aspects of the present disclosure are loaded.

The computer-readable storage medium may be a tangible device that can retain and store instructions for use by an instruction execution device. For example, the computer-readable storage medium may be, but is not limited to, an electrical storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard disk, a random access memory (RAM), a read-only memory (ROM), an erasable programmable read-only memory (EPROM or a flash memory), a static random access memory (SRAM), a portable compact disk read-only memory (CD-ROM), a digital versatile disk (DVD), a memory stick, a floppy disk, a mechanical encoding device such as a punch card or protrusions in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

Computer program instructions for performing the operations of the present disclosure may be assembly instructions, Instruction Set Architecture (ISA) instructions, machine instructions, machine-related instructions, microcode, firmware instructions, status setting data, or source code or object code written in any combination of one or more programming languages, including object-oriented programming languages as well as conventional procedural programming languages. The computer-readable program instructions may be executed entirely on a user's computer, partly on a user's computer, as a stand-alone software package, partly on a user's computer and partly on a remote computer, or entirely on a remote computer or a server. In a case where a remote computer is involved, the remote computer can be connected to a user computer through any kind of networks, including a local area network (LAN) or a wide area network (WAN), or can be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions to implement various aspects of the present disclosure.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flow charts and/or block diagrams.

The computer-readable program instructions may also be loaded to a computer, other programmable data processing apparatuses, or other devices, so that a series of operating steps may be executed on the computer, the other programmable data processing apparatuses, or the other devices to produce a computer-implemented process, such that the instructions executed on the computer, the other programmable data processing apparatuses, or the other devices may implement the functions/actions specified in one or more blocks in the flow charts and/or block diagrams.

The flow charts and block diagrams in the drawings illustrate the architectures, functions, and operations of possible implementations of the devices, methods, and computer program products according to various embodiments of the present disclosure. In this regard, each block in the flow charts or block diagrams may represent a module, a program segment, or part of an instruction, the module, program segment, or part of the instruction including one or more executable instructions for implementing specified logical functions. In some alternative implementations, the functions denoted in the blocks may also occur in an order different from that denoted in the drawings. For example, two consecutive blocks may in fact be executed substantially concurrently, and sometimes they may also be executed in a reverse order, depending on the functions involved. It should be further noted that each block in the block diagrams and/or flow charts as well as a combination of blocks in the block diagrams and/or flow charts may be implemented by a dedicated hardware-based system executing specified functions or actions, or by a combination of a dedicated hardware and computer instructions.

Various embodiments of the present disclosure have been described above. The foregoing description is illustrative rather than exhaustive, and is not limited to the disclosed various embodiments. Numerous modifications and alterations are apparent to those of ordinary skill in the art without departing from the scope and spirit of the illustrated embodiments. The selection of terms as used herein is intended to best explain the principles and practical applications of the various embodiments or the technical improvements to technologies on the market, or to enable other persons of ordinary skill in the art to understand the embodiments disclosed herein.

1. A method for scheduling container resources, comprising:
detecting, in response to that there are no available virtual devices among virtual devices assigned to one or more pods on a host, whether there is a group of idle virtual devices not assigned to the one or more pods, wherein each virtual device is operated by a physical acceleration device among a plurality of physical acceleration devices of the host; and
processing, in response to absence of the group of virtual devices, a workload of the one or more pods by using a central processing unit (CPU) of the host.

2. The method according to claim 1, further comprising:
assigning, in response to the presence of the group of virtual devices, the group of virtual devices to at least one pod in the one or more pods for processing a workload of the at least one pod.

3. The method according to claim 2, further comprising:
processing, by using the CPU, workloads of other pods in the one or more pods than the at least one pod.

4. The method according to claim 2, wherein assigning the group of virtual devices to the at least one pod comprises:
determining the at least one pod based on types of respective workloads of the one or more pods.

5. The method according to claim 4, wherein determining the at least one pod comprises:
determining, based on the types of the respective workloads of the one or more pods, priorities for assigning the group of virtual devices to the one or more pods; and
determining the at least one pod based on the priorities and a number of the group of virtual devices.

6. The method according to claim 5, wherein determining the priorities for assigning the group of virtual devices to the one or more pods comprises:
determining, for a corresponding pod in the one or more pods, a priority score for the corresponding pod based on proportions of respective types of workloads of the corresponding pod in its total workload and consumption levels of the respective types of workloads for computing resources; and
determining the priorities based on the respective priority scores of the one or more pods.

7. The method according to claim 1, further comprising:
detecting, in response to detecting that an unavailable virtual device is recovered, whether there is a pod that does not have an available virtual device on the host; and
assigning, in response to that the pod is detected, the recovered virtual device to the pod for performing a workload for the pod.

8. The method according to claim 7, further comprising:
detecting, after assigning the recovered virtual device to the pod, occupation rates of respective virtual devices of the plurality of physical acceleration devices; and
adjusting, based on the occupation rates, assignment of the virtual devices of the plurality of physical acceleration devices among the various pods on the host.

9. An electronic device, comprising:
a processor; and
a memory coupled to the processor, wherein the memory has instructions stored therein, and the instructions, when executed by the processor, cause the device to perform actions comprising:
detecting, in response to that there are no available virtual devices among virtual devices assigned to one or more pods on a host, whether there is a group of idle virtual devices not assigned to the one or more pods, wherein each virtual device is operated by a physical acceleration device among a plurality of physical acceleration devices of the host; and
processing, in response to the absence of the group of virtual devices, a workload of the one or more pods by using a central processing unit (CPU) of the host.

10. The device according to claim 9, wherein the actions further comprise:
assigning, in response to the presence of the group of virtual devices, the group of virtual devices to at least one pod in the one or more pods for processing a workload of the at least one pod.

11. The device according to claim 10, wherein the actions further comprise:
processing, by using the CPU, workloads of other pods in the one or more pods than the at least one pod.

12. The device according to claim 10, wherein assigning the group of virtual devices to the at least one pod comprises:
determining the at least one pod based on types of respective workloads of the one or more pods.

13. The device according to claim 12, wherein determining the at least one pod comprises:
determining, based on the types of the respective workloads of the one or more pods, priorities for assigning the group of virtual devices to the one or more pods; and
determining the at least one pod based on the priorities and a number of the group of virtual devices.

14. The device according to claim 13, wherein determining the priorities for assigning the group of virtual devices to the one or more pods comprises:
determining, for a corresponding pod in the one or more pods, a priority score for the corresponding pod based on proportions of respective types of workloads of the corresponding pod in its total workload and consumption levels of the respective types of workloads for computing resources; and
determining the priorities based on the respective priority scores of the one more pods.

15. The device according to claim 9, wherein the actions further comprise:
detecting, in response to detecting that an unavailable virtual device is recovered, whether there is a pod that does not have an available virtual device on the host; and
assigning, in response to that the pod is detected, the recovered virtual device to the pod for performing a workload for the pod.

16. The device according to claim 15, wherein the actions further comprise:
detecting, after assigning the recovered virtual device to the pod, occupation rates of respective virtual devices of the plurality of physical acceleration devices; and
adjusting, based on the occupation rates, assignment of the virtual devices of the plurality of physical acceleration devices among the various pods on the host.

17. A computer program product tangibly stored on a computer-readable medium and comprising machine-executable instructions, wherein the machine-executable instructions, when executed, cause a machine to perform actions comprising:
detecting, in response to that there are no available virtual devices among virtual devices assigned to one or more pods on a host, whether there is a group of idle virtual devices not assigned to the one or more pods, wherein each virtual device is operated by a physical acceleration device among a plurality of physical acceleration devices of the host; and
processing, in response to the absence of the group of virtual devices, a workload of the one or more pods by using a central processing unit (CPU) of the host.

18. The computer program product according to claim 17, wherein the actions further comprise:
assigning, in response to the presence of the group of virtual devices, the group of virtual devices to at least one pod in the one or more pods for processing a workload of the at least one pod.

19. The computer program product according to claim 18, wherein the actions further comprise:
processing, by using the CPU, workloads of other pods in the one or more pods than the at least one pod.

20. The computer program product according to claim 18, wherein assigning the group of virtual devices to the at least one pod comprises:
determining the at least one pod based on types of respective workloads of the one or more pods.
